(19) United States
(12) Patent Application Publication
(10) Pub. No.: US 2006/0291935 A1
(43) Pub. Date: Dec. 28, 2006

(54) Apparatus for useby date label printing

(76) Inventor: Daniel James Plecas, Perth (AU)

Correspondence Address: Mr. Daniel Plecas, PO BOX 875 KALAMUNDA, PERTH, WESTERN AUSTRALIA, 6926, AU

(21) Appl. No.: 11/305,204

(22) Filed: Dec. 19, 2005

Related U.S. Application Data
(60) Provisional application No. 60/639,487, filed on Dec. 29, 2004.

(51) Int. Cl. B41J 11/44

(52) U.S. Cl. 400/76

(57) ABSTRACT

The invention comprises a compact electronic apparatus for the purpose of instantly recalculating and printing useby date labels. Once a processed food is exposed to the atmosphere, opened from its manufacturer's packaging (example; opening a can of tuna) then the original manufacturer's recommended useby date may no longer apply, also in order to maintain a level of freshness after a vegetable/salad has been prepared (example; slicing a tomato) then it is necessary to nominate a useby date. The method commonly employed without this invention involves a hand written label and mental calculation of the new useby date and is subject to error and illegible handwriting. This apparatus calculates a new useby date for a perishable product when the products original useby date may no longer apply, based on individual parameters, and then prints a label detailing various information importantly including the new recalculated useby date.

The invention comprises a compact electronic apparatus for the purpose of instantly printing useby date labels on demand. The apparatus may interface to a commercially available electronic printer.

Once a processed food is exposed to the atmosphere, opened from its manufacturer's packaging (example; opening a can of tuna) then the original manufacturer's recommended useby date may no longer apply, also in order to maintain a level of freshness after a vegetable/salad has been prepared (example; the slicing of a tomato) then it is necessary to monitor the shelf life of the product closely by nominating a new useby date.

A simple one-finger operation of the apparatus enters the food type and then the apparatus calculates the new useby date from the apparatus's internal real time clock and register of opened food product storage times and based on the individual food product parameters then prints a label detailing the time and day of printing, the product name and importantly the new useby date.

The method commonly employed without this invention involves a hand written label and mental calculation of the new useby date and is subject to error and illegible handwriting. This apparatus offers significant improvements in the speed, the accuracy and the legibility of producing a label when compared to producing a hand written label.

The current day of the week and current time is printed and the useby date is calculated and printed. The apparatus may round the time stamp that is printed. The apparatus stores numeric data representing date offset values representing the longest shelf life time of the opened product and other parameters. The apparatus contains a real time clock and calendar date function. The apparatus provides a simple means for the user to set the date and time of the clock.

The current date and current time may be shown on the apparatus user display when the apparatus is powered and has not been used for a short while.

The apparatus has a user interactive menu system that may be accessed via the apparatus key buttons and apparatus user display. The apparatus menu operation is described below.

Product Menu.

The user is prompted to enter a product and when a valid product is entered or product key selected that product name is shown on the apparatus user display. Other parameters may also be entered. The apparatus enables viewing and editing of the list of products and associated parameters in the register.

Staff Menu.

If the staff function is enabled the user is prompted to enter his or her staff identification and then when a valid staff identification is entered the staff name is shown on the apparatus user display. If the staff function is enabled the apparatus enables viewing and editing of the list of staff in the register.

Print Quantity Menu.

The user is prompted to enter the number of labels to print. This number may be incremented or if above zero, decremented by pressing the plus and minus keys respectively. Alternatively the apparatus may assume a programmed quantity of labels. When all required data has been entered the apparatus begins printing the required number of labels. The apparatus may report printer error messages on the apparatus user display, but this is not always the case.

The apparatus may have an escape key and will revert to the previous or top menu level when the escape key or the escape soft key is pressed. The display and controls may be constructed from individual key buttons and digital display units or a digital display with touch sensitivity.

1. This apparatus calculates a new useby date for a perishable product when the products original useby date may no longer apply, due to the products exposure to the atmosphere or the products preparation for use, by using the apparatus's internal real time clock and individual product parameters stored in the apparatus's internal register.

2. The register of individual product parameters stored in the apparatus defined in claim 1 used for the calculation of the new useby date may also be user programmable.

3. The apparatus's from claim 1 and 2 may print the calculated useby date and other associated information to an external or integrated printer.

4. The calculation referred to in claim 1, 2 and 3 may include parameters relating to the time that a product has been thawing from a previously frozen state.

5. The calculation referred to in claim 1, 2 and 3 may include parameters relating to the time that a product has been thawed from a previously frozen state.

6. The calculation referred to in claim 1, 2 and 3 may include parameters relating to the method of preparation of a product for use.

7. The calculation referred to in claim 1, 2 and 3 may include parameters relating to any previous time that a product was first opened from its manufactures original packaging.
